(19) United States
(12) Patent Application Publication
(10) Pub. No.: US 2009/0108104 A1
(43) Pub. Date: Apr. 30, 2009

(54) SWITCH MECHANISM FOR SELECTIVELY MIXING TWO FLUIDS

(76) Inventor: Gordon CHIH, Lu-Kang Chen (TW)

Correspondence Address: SINORICA, LLC, 528 FALLSGROVE DRIVE, ROCKVILLE, MD, 20850, US

(21) Appl. No.: 12/254,153

(22) Filed: Oct. 20, 2008

(30) Foreign Application Priority Data
Oct. 29, 2007 (TW) 096218159

(51) Int. Cl. B05B 7/04

(52) U.S. Cl. 239/407

(57) ABSTRACT

A switch mechanism for selectively mixing two fluids includes a chamber, a resilient partitioning assembly, a liquid additive receptacle, a joint seat and a selection switch. The chamber has a first end formed with an inlet and a first opening, a second end formed with an outlet and a second opening, and a main passage communicating the inlet with the outlet. The resilient partitioning assembly is disposed in the chamber to partition the chamber into a first receiving space communicating with the first opening and a second receiving space communicating with the second opening. The liquid additive receptacle is for filling a liquid additive into the second receiving space. The joint seat is disposed between the inlet and the first opening and formed with a flow way communicating with the inlet. The selection switch is arranged on the joint seat between the flow way and the first opening.

### BACKGROUND OF THE INVENTION

The present invention is related generally to a switch of a fluid pipeline, and more particularly to a switch mechanism for selectively mixing two fluids.

A conventional gardening squirt gun, oscillating sprinkler, car-washing gun or squirt brush is able to squirt water. In the case an additive such as a fertilizer, an agricultural chemical, a detergent or water wax is needed, the additive is additionally used. In other words, the sprinkler and the additive must be independently used. This is laborious and time-consuming.

A sprinkler equipped with a container has been developed. The container is combined with the sprinkler and positioned inside the sprinkler for containing an additive. The container is formed with a through hole directly communicating with the water passage of the sprinkler. In use, water flow will flow through the sprinkler and fill into the container to mix with the additive. At the same time, the water flow will entrain the additive out of the container. According to this design, the additive will be more and more diluted to reduce the concentration thereof. Moreover, the amount of the entrained additive is inconstant. Furthermore, sometimes the additive will backflow along with the water flow to the water supply and thereby contaminate the water supply. Therefore, it is quite inconvenient and troublesome to use such sprinkler.

There is another conventional type of sprinkler. In this sprinkler, the through hole of the container does not direct communicate with the water passage of the sprinkler. Instead, the through hole is positioned under the water passage of the sprinkler. In use, the additive will be still entrained by the water flow out of the container. Accordingly, the additive will be more and more diluted to reduce the concentration thereof.

No matter how the container is configured and arranged, the water inlet switch of the sprinkler is positioned between the water inlet and the container of the sprinkler. Once the switch is switched off, the water flow will mix with the additive to dilute the same.

### SUMMARY OF THE INVENTION

It is therefore a primary object of the present invention to provide a switch mechanism for selectively mixing two fluids. The switch mechanism has a modularized configuration and can be conveniently independently assembled.

It is a further object of the present invention to provide the above switch mechanism for selectively mixing two fluids, in which the concentration of an additive will not changed.

It is still a further object of the present invention to provide the above switch mechanism for selectively mixing two fluids, in which the additive is prevented from contaminating water supply.

It is still a further object of the present invention to provide the above switch mechanism for selectively mixing two fluids, which switch mechanism can be added to any existent water squirter and co-used therewith to save cost.

According to the above objects, the switch mechanism for selectively mixing two fluids of the present invention includes a chamber, a resilient partitioning assembly, a liquid additive receptacle, a joint seat and a selection switch. The chamber has a first end formed with an inlet and a first opening, a second end formed with an outlet and a second opening, and a main passage communicating the inlet with the outlet. The resilient partitioning assembly is disposed between an inner circumference of the chamber and an outer circumference of the main passage. The resilient partitioning assembly partitions the chamber into a first receiving space communicating with the first opening and a second receiving space communicating with the second opening. The liquid additive receptacle is for filling a liquid additive into the second receiving space. The joint seat is disposed between the inlet and the first opening and formed with a flow way communicating with the inlet. The selection switch is arranged on the joint seat between the flow way and the first opening. The selection switch includes an outer sleeve section and an inner sleeve member.

The present invention can be best understood through the following description and accompanying drawings wherein:

### BRIEF DESCRIPTION OF THE DRAWINGS

FIG. 1 is a perspective assembled view of a preferred embodiment of the present invention;

FIG. 2 is a perspective exploded view of the preferred embodiment of the present invention;

FIG. 3 is a front view of the preferred embodiment of the present invention;

FIG. 4 is a sectional view taken along line A-A of FIG. 3;

FIG. 5 is a perspective view of the inner sleeve of the preferred embodiment of the present invention;

FIG. 6 is a perspective view of the inner sleeve of the preferred embodiment of the present invention according to FIG. 5, seen in another direction;

FIG. 7 is a top view of the preferred embodiment of the present invention, showing that the selection switch is positioned in a position where the additive is not used;

FIG. 8 is a partially sectional view taken along line B-B of FIG. 7;

FIG. 9 is a top view of the preferred embodiment of the present invention, showing that the selection switch is positioned in a position where a little amount of additive is used;

FIG. 10 is a partially sectional view taken along line C-C of FIG. 9;

FIG. 11 is a top view of the preferred embodiment of the present invention, showing that the selection switch is positioned in a position where a middle amount of additive is used;

FIG. 12 is a partially sectional view taken along line D-D of FIG. 11;

FIG. 13 is a top view of the preferred embodiment of the present invention, showing that the selection switch is positioned in a position where a large amount of additive is used;

FIG. 14 is a partially sectional view taken along line E-E of FIG. 13;

FIG. 15 is a top view of the preferred embodiment of the present invention, showing that the selection switch is positioned in a draining position;

FIG. 16 is a partially sectional view taken along line F-F of FIG. 15;

FIG. 17 is a perspective view of the inner sleeve of the further preferred embodiment of the present invention;

FIG. 18 is a top view of the further preferred embodiment of the present invention, showing that the selection switch is positioned in a position where a large amount of additive is used;

FIG. 19 is a partially sectional view taken along line G-G of FIG. 18; and

FIG. 20 is a partially sectional view of the further preferred embodiment of the present invention, showing that the block of the selection switch is positioned in a position where the additive is not used.

### DETAILED DESCRIPTION OF THE PREFERRED EMBODIMENTS

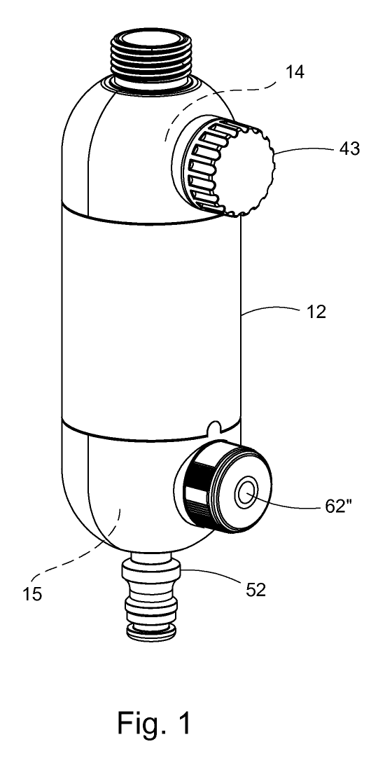

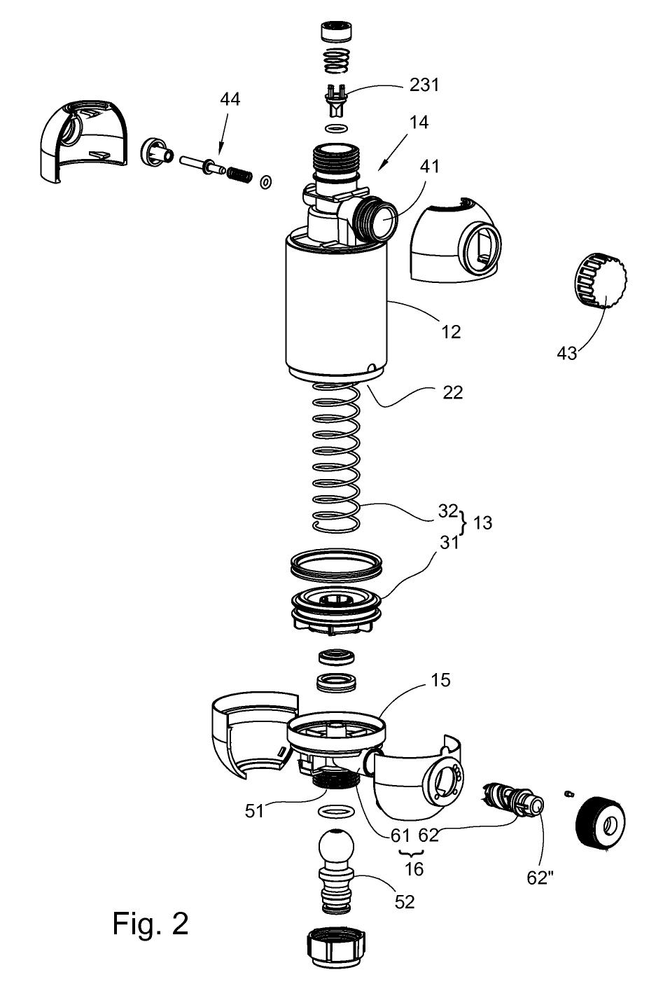

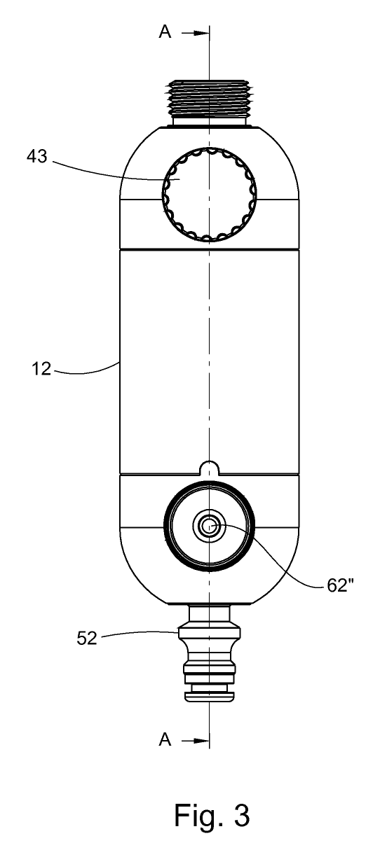

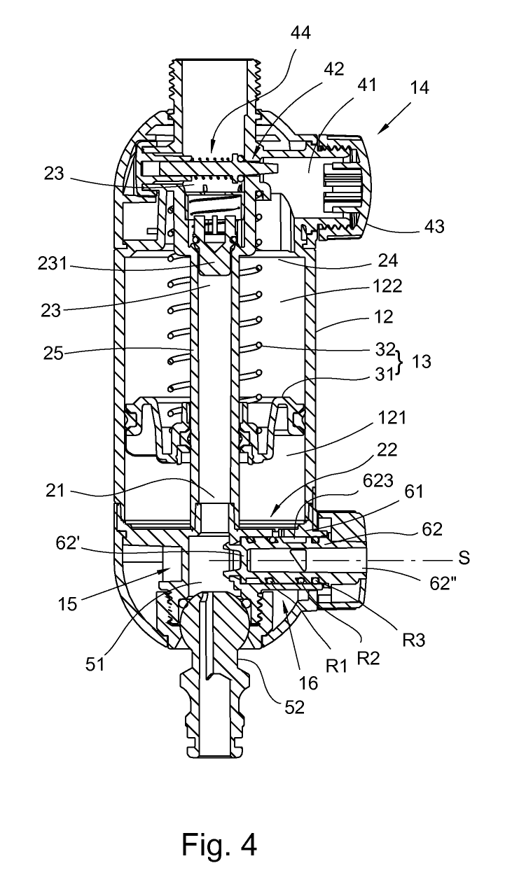

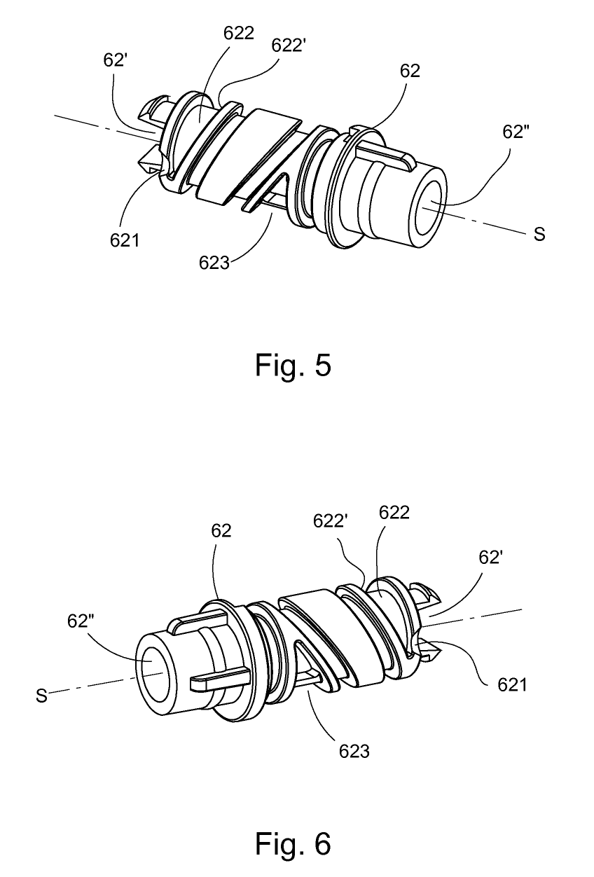

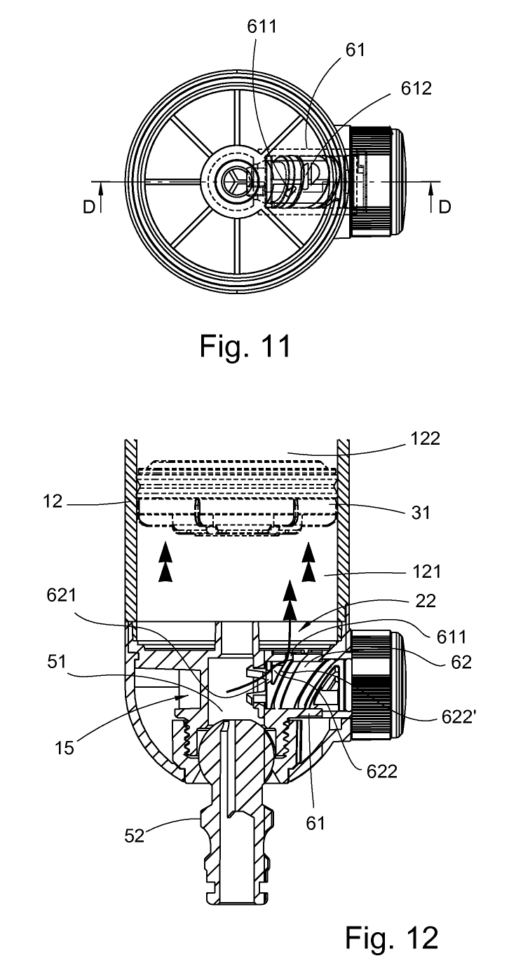

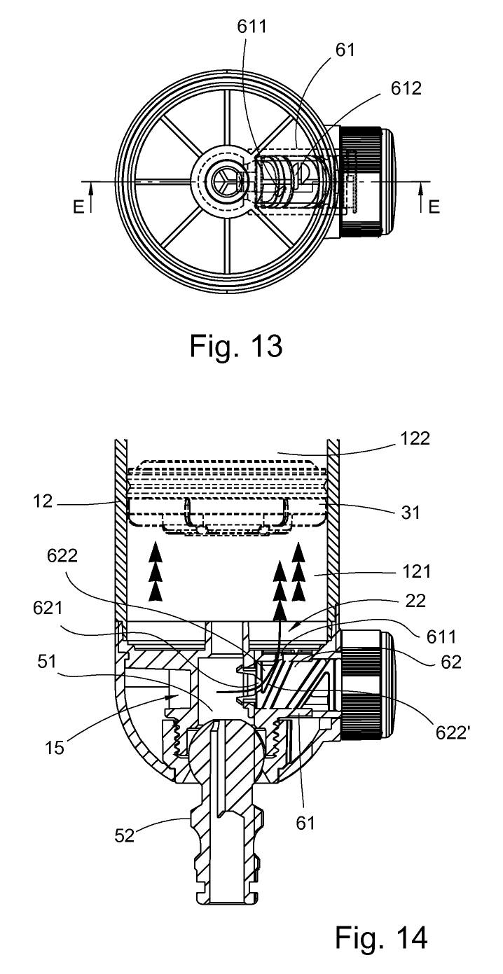

Please refer to FIGS. 1 to 16. The switch mechanism for selectively mixing two fluids of the present invention includes a chamber 12, a resilient partitioning assembly 13, a liquid additive receptacle 14, a joint seat 15 and a selection switch 16.

The chamber 12 has a first end and a second end. The first end is formed with an inlet 21 and a first opening 22. The second end is formed with an outlet 23 and a second opening 24. The chamber 12 further has a main passage 25 communicating the inlet 21 with the outlet 23.

The resilient partitioning assembly 13 is disposed between an inner circumference of the chamber 12 and an outer circumference of the main passage 25. The resilient partitioning assembly 13 includes a piston 31 and a coiled spring 32. The piston 32 is fitted around the main passage 25 and reciprocally movable between the first and second ends of the chamber 12. Accordingly, a first receiving space 121 is defined between the piston 31 and the first opening 22. The first receiving space 121 communicates with the first opening 22. A second receiving space 122 is defined between the piston 31 and the second opening 24. The second receiving space 122 communicates with the second opening 24. The coiled spring 32 is fitted around the main passage 25 and positioned between the piston 31 and the outlet 23. Two ends of the coiled spring 32 respectively abut against the piston 31 and a wall of the chamber 12. The coiled spring 32 serves to resiliently urge the piston 31 toward the first opening 22.

The liquid additive receptacle 14 is positioned between the outlet 23 and the second opening 24, at least including a first aperture 41, a second aperture 42, a cap member 43 and a check valve 44. The first aperture 41 communicates with the second receiving space 122. A liquid additive, such as a detergent, a liquid fertilizer, a liquid agricultural chemical, water wax, etc. can be filled into the second receiving space 122 through the first opening 41. The cap member 43 is used to close the aperture 41. The second aperture 42 communicates with the outlet 23 and the second opening 24. The check valve 44 is positioned between the outlet 23 and the second aperture 42, whereby the liquid additive can only one-way flow from the second opening 24 to the outlet 23.

The joint seat 15 is disposed between the inlet 21 and the first opening 22. The joint seat 15 is formed with a flow way 51 communicating with the inlet 21. One end of a universal joint 52 communicates with the flow way 51. The other end of the universal joint 52 can communicate with a water pipe, whereby water flow can flow through the joint 52 into the way flow 51 and further flow toward the outlet 23.

The selection switch 16 is arranged on the joint seat 15 and positioned between the flow way 51 and the first opening 22. The selection switch 16 includes an outer sleeve section 61 and an inner sleeve member 62.

The outer sleeve section 61 is a hollow body having two open ends. One of the open ends of the outer sleeve section 61 communicates with the flow way 51. The outer sleeve section 61 has a circular inner circumference. An outgoing hole 611 and an outer draining hole 612 are formed on one side of the outer sleeve section 61 to communicate the first opening 22 with an interior of the outer sleeve section 61.

The inner sleeve member 62 is a hollow body having a closed end 62′ and an open end 62″. The inner sleeve member 62 has an outer circumference adapted to the inner circumference of the outer sleeve section 61 in shape. The inner sleeve member 62 is fitted in the outer sleeve section 61 and rotatable about a rotational axis S between a first position and a second position.

The closed end 62′ of the inner sleeve member 62 is adjacent to the flow way 51. An outer face of the closed end 62′ is formed with at least one notch 621 communicating with the flow way 51. A groove 622 is formed on a portion of the outer circumference of the inner sleeve member 62, which portion is adjacent to the notch 621. The groove 622 communicates with the notch 621. An inner draining hole 623 is formed on a portion of the inner sleeve member 62, which portion is adjacent to the open end 62″. The inner draining hole 623 communicates with the open end 62″ of the inner sleeve member 62. In the first position, the groove 622 communicates with the outgoing hole 611, while in the second position, the inner draining hole 623 communicates with the outer draining hole 612. Moreover, the inner sleeve member 62 can be positioned in a third position between the first and second positions. In the third position, the groove 622 does not communicate with the outgoing hole 611 and the inner draining hole 623 does not communicate with the outer draining hole 612.

The present invention can further include a check valve 231 disposed in the outlet 23. The check valve 231 serves to prevent the water flow from backflowing to the inlet 21. Accordingly, the liquid mixture of the water and the liquid additive is hindered from backflowing to the water supply so as not to contaminate the water supply.

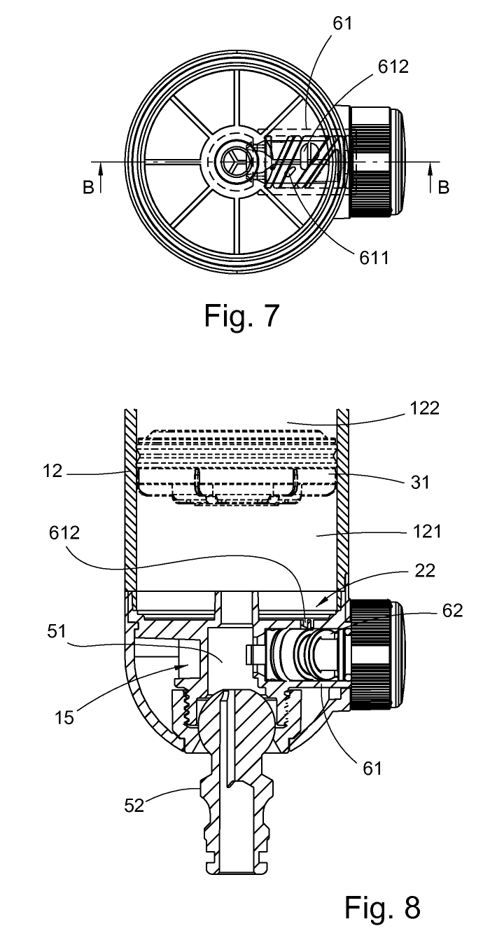

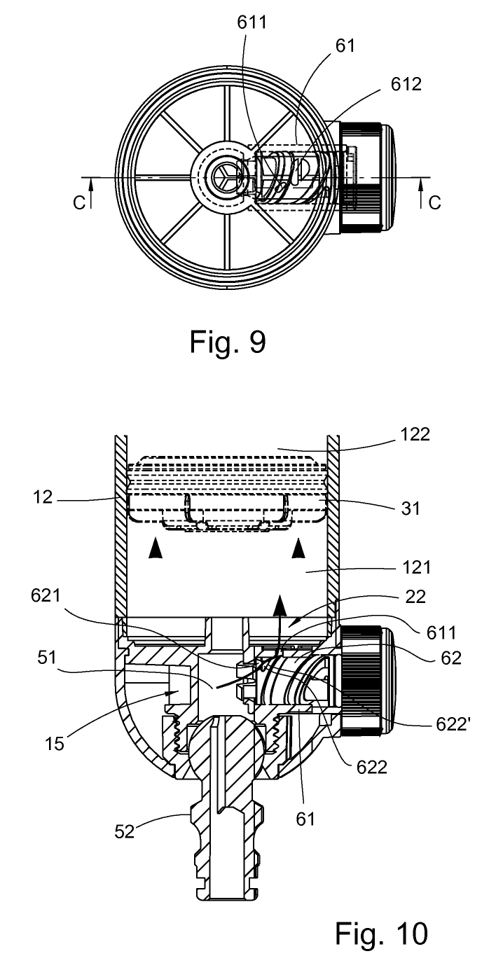

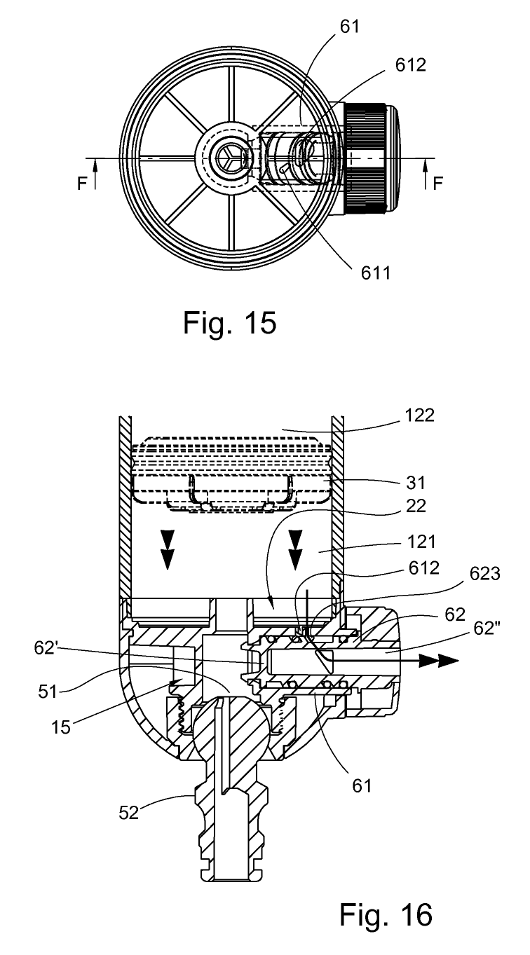

The outlet 23 of the present invention can be connected with a water squirter or a sprinkler. The flow way 51 can be connected to a faucet via the universal joint 52. The liquid additive is filled into the second receiving space 122 through the first aperture 41. Then the first aperture 41 is blocked with the cap member 43. Thereafter, the faucet and the water squirter are turned on. According to the above arrangement, the present invention is switchable between three modes as follows:
1. When the inner sleeve member 62 is positioned in the third position, the groove 622 does not communicate with the outgoing hole 611 and the inner draining hole 623 also does not communicate with the outer draining hole 612. Under such circumstance, the water will not mix with the liquid additive and the water squirter simply squirts water flow (as shown in FIGS. 7 and 8).
2. When it is necessary to use the liquid additive, a user can rotate the inner sleeve member 62 to the first position where the groove 622 communicates with the outgoing hole 611. In this state, the water flow can flow through the notch 621, the groove 622, the outgoing hole 611 and the first opening 22 into the first receiving space 121 to push the piston 31. At this time, the piston 31 pushes the liquid additive in the second receiving space 122 to flow through the second opening 24 and the second aperture 42 into the outlet 23 (as shown in FIGS. 9 to 14).
3. When the liquid additive is exhausted, the inner sleeve member 62 is rotated to the second position where the inner draining hole 623 communicates with the outer draining hole 612. Under such circumstance, the coiled spring 32 resiliently pushes the piston 31 toward the first opening 22. At this time, the water in the first receiving space 121 is urged to flow through the first opening 22, the outer draining hole 612 and the inner draining hole 623 into the open end 62″. In this state, the liquid additive can be refilled into the second receiving space 122 (as shown in FIGS. 15 and 16).

In the above structure of the present invention, two leakproof washers R1, R2 are annularly fitted on the outer circumference of the inner sleeve member 62 between the groove 622 and the inner draining hole 623 at intervals. In addition, another leakproof washer R3 is fitted around the open end 62″ of the inner sleeve member 62 between the outer circumference of the inner sleeve member 62 and the inner circumference of the outer sleeve section 61 for achieving better water-sealing effect.

In the above structure of the present invention, one side 622′ of the groove 622 communicating with the outgoing hole 611 can be inclined from the rotational axis S. Accordingly, the groove 622 can selectively communicate with the outgoing hole 611 to different extents, whereby the water flow can flow into the first receiving space 121 at different speeds to push the piston 31. As a result, the second receiving space 122 is changeable at different rates to fill different amounts of liquid additive into the outlet 23. Accordingly, by means of the inclined side 622′ of the groove 622, a user can vary the amount of the liquid additive filled into the outlet 23 as desired.

According to the above arrangements, the switch mechanism for selectively mixing two fluids of the present invention has the following advantages:
1. The main water flow will not mix with the liquid additive.
2. The components of the switch mechanism can be easily assembled.
3. The switch mechanism can be added to any existent water squirter and co-used therewith to save cost.
4. The liquid additive can be quantitatively used at a fixed concentration.

The above embodiments are only used to illustrate the present invention, not intended to limit the scope thereof. Many modifications of the above embodiments can be made without departing from the spirit of the present invention.

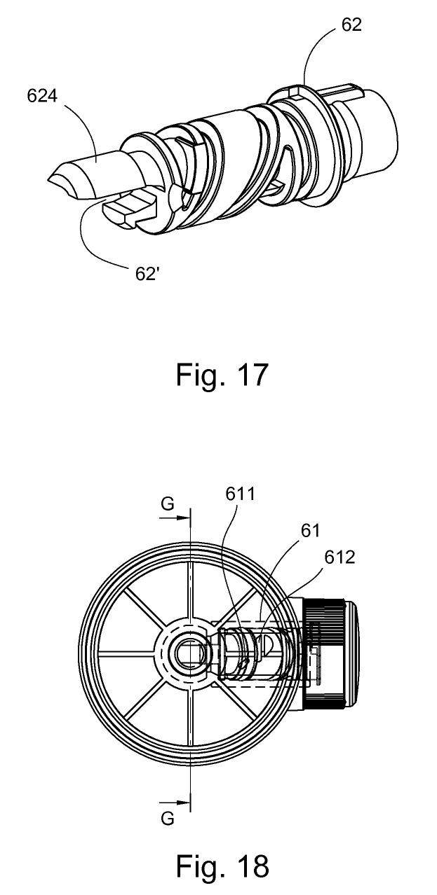

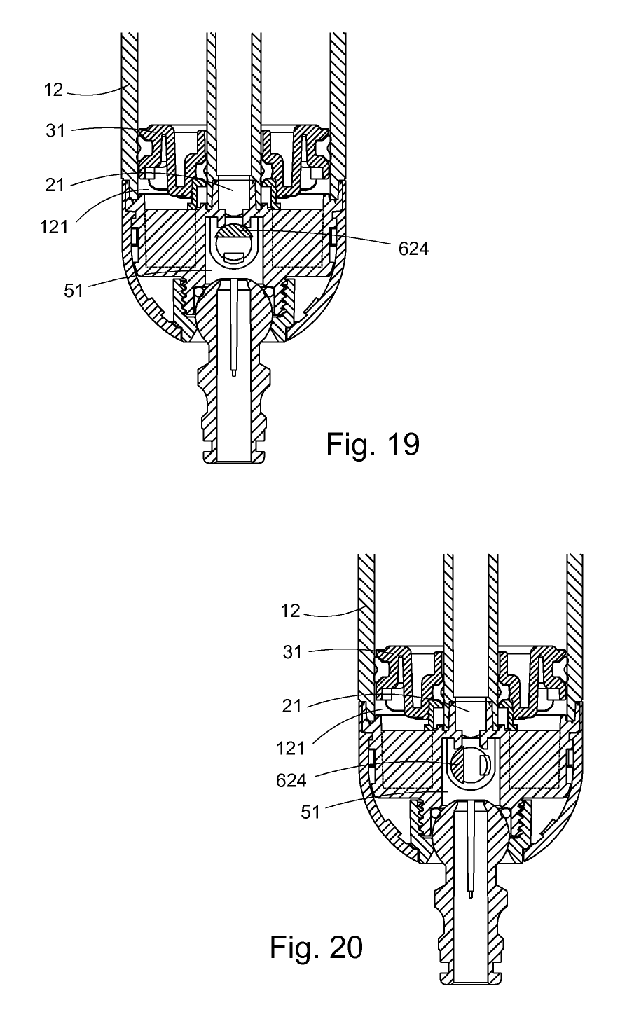

Please refer to FIGS. 17 to 20. It is the further preferred embodiment of the present invention wherein the closed end 62′ of the inner sleeve member 62 extends outward a block 624 with a semicircle transverse. The block 624 is positioned between the inlet 21 and the flow way 51. The block 624 can decrease the flow rate of the water flow into the inlet 21 and increase the flow rate of the water flow into the first receiving space 121. This design not only can enhance the ability that the water flow smoothly pushes the piston 31, but also decrease the speed of the detergent being sprayed out. A user can leisurely spray out the detergent. The detergent can be used as a high consistency. When the inner sleeve member 62 is positioned in the third position, i.e. the liquid additive like a detergent is not required, the block 624 does not obstruct the water flow into the first receiving space 121 (as shown in FIG. 20). When the inner sleeve member 62 is positioned in the second position, i.e. the liquid additive like a detergent is preparing to be refilled, the block 624 can stop the water flow into the flow way 51 for convenience.

What is claimed is:

1. A switch mechanism for selectively mixing two fluids, comprising:
a chamber having a first end and a second end, the first end being formed with an inlet and a first opening, the second end being formed with an outlet and a second opening, the chamber further having a main passage communicating the inlet with the outlet;
a resilient partitioning assembly disposed between an inner circumference of the chamber and an outer circumference of the main passage, the resilient partitioning assembly being reciprocally movable between the first and second ends of the chamber to partition the chamber into a first receiving space and a second receiving space, the first receiving being defined between the resilient partitioning assembly and the first opening, the first receiving space communicating with the first opening, the second receiving space being defined between the resilient partitioning assembly and the second opening, the second receiving space communicating with the second opening, the resilient partitioning assembly being resiliently urged toward the first opening;
a liquid additive receptacle positioned between the outlet and the second opening for filling a liquid additive into the second receiving space, the liquid additive being permitted to only one-way flow from the second opening to the outlet;
a joint seat disposed between the inlet and the first opening, the joint seat being formed with a flow way communicating with the inlet; and
a selection switch arranged on the joint seat and positioned between the flow way and the first opening, the selection switch including an outer sleeve section and an inner sleeve member, the outer sleeve section being a hollow body having two open ends, one of the open ends of the outer sleeve section communicating with the flow way, the outer sleeve section having a circular inner circumference, a communicating section being formed on one side of the outer sleeve section to communicate the first opening with an interior of the outer sleeve section, the inner sleeve member being a hollow body having a closed end and an open end, the inner sleeve member having an outer circumference adapted to the inner circumference of the outer sleeve section in shape, the inner sleeve member being fitted in the outer sleeve section and rotatable about a rotational axis between a first position and a second position, the closed end of the inner sleeve member being adjacent to the flow way, an outer face of the closed end being formed with at least one notch communicating with the flow way, a groove being formed on a predetermined portion of the outer circumference of the inner sleeve member, the groove communicating with the notch, an inner draining hole being formed on a predetermined portion of the inner sleeve member, the inner draining hole communicating with the open end of the inner sleeve member, whereby in the first position, the groove communicates with the communicating section, while in the second position, the inner draining hole communicates with the communicating section.

2. The switch mechanism for selectively mixing two fluids as claimed in claim 1, wherein the communicating section includes an outgoing hole and an outer draining hole, whereby in the first position, the groove communicates with the outgoing hole, while in the second position, the inner draining hole communicates with the outer draining hole.

3. The switch mechanism for selectively mixing two fluids as claimed in claim 2, wherein two leakproof washers are annularly fitted on the outer circumference of the inner sleeve member between the groove and the inner draining hole at intervals, another leakproof washer being fitted around the open end of the inner sleeve member between the outer circumference of the inner sleeve member and the inner circumference of the outer sleeve section.

4. The switch mechanism for selectively mixing two fluids as claimed in claim 2, wherein one side of the groove communicating with the outgoing hole is inclined from the rotational axis.

5. The switch mechanism for selectively mixing two fluids as claimed in claim 3, wherein one side of the groove communicating with the outgoing hole is inclined from the rotational axis.

6. The switch mechanism for selectively mixing two fluids as claimed in claim 1, wherein the resilient partitioning assembly includes a piston and a resilient member, the piston being fitted around the main passage, the resilient member being fitted around the main passage and positioned between the piston and the outlet, two ends of the resilient member respectively abutting against the piston and a wall of the chamber.

7. The switch mechanism for selectively mixing two fluids as claimed in claim 2, wherein the resilient partitioning assembly includes a piston and a resilient member, the piston being fitted around the main passage, the resilient member being fitted around the main passage and positioned between the piston and the outlet, two ends of the resilient member respectively abutting against the piston and a wall of the chamber.

8. The switch mechanism for selectively mixing two fluids as claimed in claim 3, wherein the resilient partitioning assembly includes a piston and a resilient member, the piston being fitted around the main passage, the resilient member being fitted around the main passage and positioned between the piston and the outlet, two ends of the resilient member respectively abutting against the piston and a wall of the chamber.

9. The switch mechanism for selectively mixing two fluids as claimed in claim 4, wherein the resilient partitioning assembly includes a piston and a resilient member, the piston being fitted around the main passage, the resilient member being fitted around the main passage and positioned between the piston and the outlet, two ends of the resilient member respectively abutting against the piston and a wall of the chamber.

10. The switch mechanism for selectively mixing two fluids as claimed in claim 5, wherein the resilient partitioning assembly includes a piston and a resilient member, the piston being fitted around the main passage, the resilient member being fitted around the main passage and positioned between the piston and the outlet, two ends of the resilient member respectively abutting against the piston and a wall of the chamber.

11. The switch mechanism for selectively mixing two fluids as claimed in claim 1, further comprising a check valve disposed in the outlet for preventing a fluid from flowing to the inlet.

12. The switch mechanism for selectively mixing two fluids as claimed in claim 2, further comprising a check valve disposed in the outlet for preventing a fluid from flowing to the inlet.

13. The switch mechanism for selectively mixing two fluids as claimed in claim 4, further comprising a check valve disposed in the outlet for preventing a fluid from flowing to the inlet.

14. The switch mechanism for selectively mixing two fluids as claimed in claim 6, further comprising a check valve disposed in the outlet for preventing a fluid from flowing to the inlet.

15. The switch mechanism for selectively mixing two fluids as claimed in claim 7, further comprising a check valve disposed in the outlet for preventing a fluid from flowing to the inlet.

16. A switch mechanism for selectively mixing two fluids, comprising:
a joint seat formed with a flow way; and
a selection switch arranged on one side of the joint seat, the selection switch including an outer sleeve section and an inner sleeve member, the outer sleeve section being a hollow body having two open ends, one of the open ends of the outer sleeve section communicating with the flow way, the outer sleeve section having a circular inner circumference, a communicating section being formed on one side of the outer sleeve section to communicate an exterior of the outer sleeve section and an interior of the outer sleeve section, the inner sleeve member being a hollow body having a closed end and an open end, the inner sleeve member having an outer circumference adapted to the inner circumference of the outer sleeve section in shape, the inner sleeve member being fitted in the outer sleeve section and rotatable about a rotational axis between a first position and a second position, the closed end of the inner sleeve member being adjacent to the flow way, an outer face of the closed end being formed with at least one notch communicating with the flow way, a groove being formed on a predetermined portion of the outer circumference of the inner sleeve member, the groove communicating with the notch, an inner draining hole being formed on a predetermined portion of the inner sleeve member, the inner draining hole communicating with the open end of the inner sleeve member, whereby in the first position, the groove communicates with the communicating section, while in the second position, the inner draining hole communicates with the communicating section.

17. The switch mechanism for selectively mixing two fluids as claimed in claim 16, wherein the communicating section includes an outgoing hole and an outer draining hole, whereby in the first position, the groove communicates with the outgoing hole, while in the second position, the inner draining hole communicates with the outer draining hole.

18. The switch mechanism for selectively mixing two fluids as claimed in claim 17, wherein two leakproof washers are annularly fitted on the outer circumference of the inner sleeve member between the groove and the inner draining hole at intervals, another leakproof washer being fitted around the open end of the inner sleeve member between the outer circumference of the inner sleeve member and the inner circumference of the outer sleeve section.

19. The switch mechanism for selectively mixing two fluids as claimed in claim 17, wherein one side of the groove communicating with the outgoing hole is inclined from the rotational axis.

20. The switch mechanism for selectively mixing two fluids as claimed in claim 18, wherein one side of the groove communicating with the outgoing hole is inclined from the rotational axis.

21. The switch mechanism for selectively mixing two fluids as claimed in claim 1, wherein the closed end of the inner sleeve member extends outward a block with a semicircle transverse being positioned between the inlet and the flow way.

22. The switch mechanism for selectively mixing two fluids as claimed in claim 6, wherein the closed end of the inner sleeve member extends outward a block with a semicircle transverse being positioned between the inlet and the flow way.
